(19) United States
(12) Patent Application Publication
(10) Pub. No.: US 2023/0178732 A1
(43) Pub. Date: Jun. 8, 2023

(54) Lithium-Ion Secondary Battery and Manufacturing Method for the Same

(71) Applicant: Nippon Telegraph and Telephone Corporation, Tokyo (JP)

(72) Inventors: Akihiro Kono, Musashino-shi, Tokyo (JP); Hironobu Minowa, Musashino-shi, Tokyo (JP); Yoko Ono, Musashino-shi, Tokyo (JP); Takeshi Komatsu, Musashino-shi, Tokyo (JP)

(21) Appl. No.: 17/921,901

(22) PCT Filed: May 21, 2020
(86) PCT No.: PCT/JP2020/020134

§ 371 Date: Oct. 27, 2022

(51) Int. Cl. H01M 4/58; H01M 10/0525; H01M 4/587; H01M 4/36; C01B 25/455

(52) U.S. Cl. CPC H01M 4/5825; H01M 10/0525; H01M 4/587; H01M 4/366; C01B 25/455; H01M 2004/028

(57) ABSTRACT

A lithium ion secondary battery has, as a positive electrode active material into and from which lithium ions can be intercalated and deintercalated, a lithium oxide represented by Formula Li(1+y)CoPO₄X(y) (in the formula, X is selected from the group consisting of F, Cl, Br and I, and y lies in the range of 1<y≤2).

### TECHNICAL FIELD

The present invention relates to a lithium ion secondary battery and to a production method thereof.

### BACKGROUND ART

Lithium-ion secondary batteries that rely on lithium-ion intercalation and deintercalation reactions are widely used as secondary batteries of high energy density in various electronic devices, automotive power sources, power storage and the like. There is ongoing research and development being devoted to electrode materials and electrolyte materials, with a view to enhancing performance and reducing costs.

Lithium ion secondary batteries have recently attracted attention as mobile power sources in the wake of the development of IT devices such as smartphones and IoT devices. Batteries for these devices may need to exhibit new characteristics, for the purpose product differentiation. For instance flexibility and the like has become apparent as one such new characteristic.

A flexible battery is reported for instance in Non Patent Literature 1. This battery is reported to be thin and bendable, and to exhibit a discharge capacity of about 250 μAh/g at a discharge current having a current density of 0.1 mA/cm².

### CITATION LIST

### Non Patent Literature

[NPL 1] Masahiko Hayashi, et al., “Preparation and electrochemical properties of pure lithium cobalt oxide films by electron cyclotron resonance sputtering”, Journal of Power Sources 189 (2009) 416 to 422.
Takanori MAHARA et al., “Enhancement in Cyclic Life Performance and Discharge Capacity of Li₂CoPO₄F by Optimization of Synthesis Method and Carbon Coating Process”, GS Yuasa Technical Report, Vol. 14 No. 1, Jun. 28, 2017

### SUMMARY OF THE INVENTION

### Technical Problem

Research is also being conducted on battery materials that transmit visible light, but such battery materials are problematic in terms of having low energy density; as a result, the materials need to be used in large quantities and the transparency of the battery as a whole is poor, all of which has precluded these materials from being put into practical use.

In Non Patent Literature 2 attention is given to Li₂CoPO₄F which is a polyanionic positive electrode active material, as an example of a battery of high voltage and high energy density. Herein Li₂CoPO₄F has two Li atoms per composition formula, and hence has a higher theoretical capacity (287 mgAh/g) than that of LiCoPO₄. The actual capacity remains however at 172 mAh/g.

That is, designs and applications in IoT devices could be significantly expanded, and further reductions in size achieved, if a battery could be realized that is transparent to visible light and has high voltage and high energy density; however, such a battery does not exist, which is problematic.

It is thus an object of the present invention, arrived at in the light of the above considerations, to provide a high-voltage lithium ion secondary battery exhibiting high transparency to visible light and having high energy density, and to provide a method for producing the lithium ion secondary battery.

### Means for Solving the Problem

An aspect of the present invention is a lithium ion secondary battery having, as a positive electrode active material into and from which lithium ions can be intercalated and deintercalated, a lithium oxide represented by Formula Li(1+y)CoPO₄X(y) (in the formula, X is selected from the group consisting of F, Cl, Br and I, and y lies in the range of 1<y≤2).

Another aspect of the present invention is a method for producing a lithium ion secondary battery, the method having a mixing and pulverizing step of obtaining a precursor by mixing and pulverizing a starting material containing Formula LiCoPO₄, and formula yLiX (in the formula, X is selected from the group consisting of F, Cl, Br and I, and y lies in the range of 1<y≤2), within a container having an inert gas enclosed therein; and a thermal treatment step of obtaining a positive electrode active material represented by Formula Li(1+y)CoPO₄X(y) (in the formula, X is selected from the group consisting of F, Cl, Br and I, and y lies in the range of 1<y≤2), by thermally treating the precursor in an inert gas.

### Effects of the Invention

The present invention allows providing a high-voltage lithium ion secondary battery exhibiting high transparency to visible light and having high energy density, and allows providing a method for producing the lithium ion secondary battery.

### BRIEF DESCRIPTION OF DRAWINGS

FIG. 1 is a schematic diagram illustrating the basic configuration of a lithium ion secondary battery according to an embodiment of the present invention.

FIG. 2 is a diagram illustrating an example of charging/discharge characteristics of the lithium ion secondary battery of Experimental example 1.

FIG. 3 is a diagram illustrating an example of charging/discharge characteristics of a lithium ion secondary battery of a comparative example.

FIG. 4 is a diagram illustrating an example of a charging and discharge cycle characteristic of the lithium ion secondary battery of Experimental example 1.

FIG. 5 is a diagram illustrating an example of light transmission characteristics of the positive electrode active materials of Experimental examples 1 and 2.

FIG. 6 is a diagram illustrating an example of light transmission characteristics of the positive electrode active materials of Experimental examples 3 and 6.

FIG. 7 is a diagram illustrating an example of light transmission characteristics of the positive electrode active materials of Experimental examples 4 and 7.

FIG. 8 is a diagram illustrating an example of light transmission characteristics of the positive electrode active materials of Experimental examples 5 and 8.

### DESCRIPTION OF EMBODIMENTS

Embodiments of the lithium ion secondary battery of the present invention will be described below.

### Construction of a Lithium Ion Secondary Battery

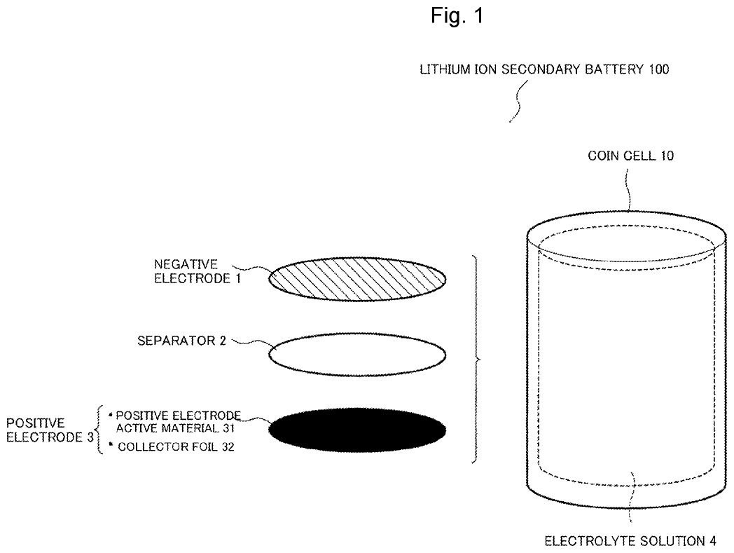

FIG. 1 is a schematic diagram illustrating the basic configuration of a lithium ion secondary battery according to the present embodiment. A lithium ion secondary battery 100 of the present embodiment has a negative electrode 1, a separator 2, a positive electrode 3, and an electrolyte solution 4. The depicted lithium ion secondary battery 100 is a coin-type battery in which the negative electrode 1, the separator 2, the positive electrode 3, and the electrolyte solution 4 are accommodated in a coin cell 10.

The negative electrode 1 contains metallic lithium, a lithium-containing substance, or a substance into and from which lithium ions can be intercalated and deintercalated. In the present embodiment lithium (Li) is used in the negative electrode 1 and polyvinylidene difluoride (PVDF) is used in the separator 2.

The electrolyte solution 4 contains an electrolyte having lithium ion conductivity. The electrolyte solution 4 of the present embodiment is an organic electrolyte solution in which a metal salt containing lithium ions, namely lithium hexafluorophosphate (LiPF₆), is dissolved in a mixed solvent of ethylene carbonate and a dialkyl carbonate (volume ratio 1:1).

The material of the negative electrode 1, the material of the separator 2, and the material of the metal salt and the organic electrolyte solution pertaining to the electrolyte solution 4 are not limited to those above, and other materials may be used.

The positive electrode 3 has a positive electrode active material 31 into and from which lithium ions can be intercalated and deintercalated, and a collector foil 32. The positive electrode active material 31 of the present embodiment contains a lithium oxide represented by Formula Li(1+y)CoPO₄X(y) (in the formula, X is selected from the group consisting of F, Cl, Br and I, and y lies in the range of 1<y≤2). Specifically, the positive electrode active material 31 contains a lithium oxide obtained through doping (intercalation) of lithium, along with a halogen (X), into LiCoPO₄, which is a polyanionic positive electrode active material. Herein Al is used as the material of the collector foil 32 of the present embodiment, but a material other than Al may also be used.

As pointed out above, the present embodiment allows providing a high-voltage lithium ion secondary battery that has high transparency to visible light and has high energy density.

### Method for Producing a Lithium Ion Secondary Battery

The positive electrode active material 31 can be obtained by mixing a lithium oxide represented by Formula Li(1+y)CoPO₄X(y) (in the formula, X is selected from the group consisting of F, Cl, Br and I, and y lies in the range of 1<y≤2), carbon which is a conductive aid, and polyvinylidene difluoride (PVDF), at arbitrary proportions, with pulverization followed by application onto the collector foil 32 using a bar coater, and with subsequent drying for 24 hours or longer.

In the present embodiment fibrous carbon is used as the carbon, but the carbon is not limited thereto, and it suffices that the carbon imparts electron conductivity. The carbon that is used may be carbon nanotubes, a fullerene, graphene, graphite or amorphous carbon.

The pulverization method may rely on the use of for instance a mixer, a homogenizer, an ultrasonic homogenizer, a high-speed rotary shear-type stirrer, a colloid mill, a roll mill, a high-pressure injection disperser, a rotary ball mill, a vibration ball mill, a planetary ball mill, an attritor or the like. Using a planetary ball mill allows for further atomization of carbon, and for increased battery capacity, and accordingly pulverization in the present embodiment is accomplished using a planetary ball mill.

To assemble the lithium ion secondary battery, the negative electrode 1, the separator 2 and the positive electrode 3 are assembled in this order in the coin cell 10, after which the electrolyte solution 4 is enclosed, with pressing to thereby enclose all the materials inside the coin cell 10.

The lithium ion secondary battery 100 can be produced as a result of the above steps.

### EXAMPLES

(I) Production of a Positive Electrode Active Material

The production of a positive electrode active material is explained next. In each of the following preparation examples a positive electrode active material (lithium oxide) was produced on the basis of the chemical reaction formula below.

LiCoPO₄+yLiX→Li(1+y)CoPO₄X(y)

The value of y is arbitrary, and as long as it is a value lying in the range of 1<y≤2, a positive electrode active material of desired chemical structure can be obtained through adjustment of the charging amount of LiX. In the preparation examples y=1.5 and 2 were adopted. Herein X is a halogen selected from the group consisting of F, Cl, Br and I.

Specifically, the method for producing a positive electrode active material includes a mixing and pulverizing step and a thermal treatment step. In the mixing and pulverizing step, starting materials including Formula LiCoPO₄ and formula yLiX are mixed and pulverized in a container filled with an inert gas, to yield a precursor. In the thermal treatment step, the precursor is thermally treated in the inert gas, to yield a positive electrode active material represented by Formula Li(1+y)CoPO₄X(y). In the formula, X is selected from the group consisting of F, Cl, Br and I, and y lies in the range of 1<y≤2.

(I) Preparation of (Li_{2.5}CoPO₄F_{1.5})

The present preparation example is a preparation example in which fluorine (F) is used as the halogen, and y=1.5.

As starting materials (starting substances), lithium cobalt phosphate (LiCoPO₄: Kojundo Kagaku KK) and lithium fluoride (LiF: FUJIFILM Wako Pure Chemical Corporation), which are commercially available reagents, were weighed so that the Co:F molar ratio was 1:1.5, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiF were mixed in a mortar, to obtain a mixture (precursor). A crucible was filled with the obtained mixture and the obtained mixture was heated at 780° C. for 24 hours in an argon atmosphere, using an electric furnace, to obtain Li_{2.5}CoPO₄F_{1.5}. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(ii) Preparation of (Li_{2.5}CoPO₄Cl_{1.5})

The present preparation example is a preparation example in which chlorine (Cl) is used as the halogen, and y=1.5.

As starting materials (starting substances), lithium cobalt phosphate (LiCoPO₄: Kojundo Kagaku KK) and lithium chloride (LiCl: FUJIFILM Wako Pure Chemical Corporation), which are commercially available reagents, were weighed so that the Co:Cl molar ratio was 1:1.5, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiCl were mixed in a mortar, to obtain a mixture (precursor). A crucible was filled with the obtained mixture and the obtained mixture was heated at 550° C. for 24 hours in an argon atmosphere, using an electric furnace, to obtain Li_{2.5}CoPO₄Cl_{1.5}. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(iii) Preparation of (Li_{2.5}CoPO₄Br_{1.5})

The present preparation example is a preparation example in which bromine (Br) is used as the halogen, and y=1.5.

As starting materials (starting substances), lithium cobalt phosphate (LiCoPO₄: Kojundo Kagaku KK) and lithium bromide (LiBr: FUJIFILM Wako Pure Chemical Corporation), which are commercially available reagents, were weighed so that the Co:Br molar ratio was 1:1.5, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiBr were mixed in a mortar, to obtain a mixture (precursor). A crucible was filled with the obtained mixture and the obtained mixture was heated at 480° C. for 24 hours in an argon atmosphere, using an electric furnace, to obtain Li_{2.5}CoPO₄Br_{1.5}. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(iv) Preparation of (Li_{2.5}CoPO₄I_{1.5})

The present preparation example is a preparation example in which iodine (I) is used as the halogen, and y=1.5.

As starting materials (starting substances), lithium cobalt phosphate (LiCoPO₄: Kojundo Kagaku KK) and lithium iodide (LiI: FUJIFILM Wako Pure Chemical Corporation), which are commercially available reagents, were weighed so that the Co:I molar ratio was 1:1.5, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiI were mixed in a mortar, to obtain a mixture (precursor). A crucible was filled with the obtained mixture and the obtained mixture was heated at 400° C. for 24 hours in an argon atmosphere, using an electric furnace, to obtain Li_{2.5}CoPO₄I_{1.5}. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(v) Preparation of (Li₃CoPO₄F₂)

The present preparation example is a preparation example in which fluorine (F) is used as the halogen, and y=2.

As starting materials (starting substances), lithium cobalt phosphate (LiCoPO₄: Kojundo Kagaku KK) and lithium fluoride (LiF: FUJIFILM Wako Pure Chemical Corporation), which are commercially available reagents, were weighed so that the Co:F molar ratio was 1:2, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiF were mixed in a mortar, to obtain a mixture (precursor). A crucible was filled with the obtained mixture and the obtained mixture was heated at 780° C. for 24 hours in an argon atmosphere, using an electric furnace, to obtain Li₃CoPO₄F₂. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(vi) Preparation of (Li₃CoPO₄Cl₂)

The present preparation example is a preparation example in which chlorine (Cl) is used as the halogen, and y=2.

As starting materials (starting substances), lithium cobalt phosphate (LiCoPO₄: Kojundo Kagaku KK) and lithium chloride (LiCl: FUJIFILM Wako Pure Chemical Corporation), which are commercially available reagents, were weighed so that the Co:Cl molar ratio was 1:2, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiCl were mixed in a mortar, to obtain a mixture (precursor). A crucible was filled with the obtained mixture and the obtained mixture was heated at 550° C. for 24 hours in an argon atmosphere, using an electric furnace, to obtain Li₃CoPO₄Cl₂. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(vii) Preparation of (Li₃CoPO₄Br₂)

The present preparation example is a preparation example in which bromine (Br) is used as the halogen, and y=2.

As starting materials (starting substances), lithium cobalt phosphate (LiCoPO₄: Kojundo Kagaku KK) and lithium bromide (LiBr: FUJIFILM Wako Pure Chemical Corporation), which are commercially available reagents, were weighed so that the Co:Br molar ratio was 1:2, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiBr were mixed in a mortar, to obtain a mixture (precursor). A crucible was filled with the obtained mixture and the obtained mixture was heated at 480° C. for 24 hours in an argon atmosphere, using an electric furnace, to obtain Li₃CoPO₄Br₂. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

(viii) Preparation of (Li₃CoPO₄I₂)

The present preparation example is a preparation example in which iodine (I) is used as the halogen, and y=2.

As starting materials (starting substances), lithium cobalt phosphate (LiCoPO₄: Kojundo Kagaku KK) and lithium iodide (LiI: FUJIFILM Wako Pure Chemical Corporation), which are commercially available reagents, were weighed so that the Co:I molar ratio was 1:2, were mixed with zirconia beads, and were pulverized using a planetary ball mill.

Pulverization was carried out in an inert atmosphere, using PM100 by Retsch GmbH as the planetary ball mill, and with an inert gas sealed in the container of the planetary ball mill. Zirconia beads having a diameter of 1.5 mm and zirconia beads having a diameter of 0.9 mm were used mixed with each other. Although pulverization is possible in an air atmosphere, an inert atmosphere is however preferable herein since in that case no by-products are formed through reaction with oxygen.

The revolution speed of the planetary ball mill was set to 400 rpm. The speed ratio was fixed to 1:−2. In a case where zirconia beads having a diameter larger than 1.5 mm were used, pulverization was not carried out, and a desired substance could not be obtained in the below-described thermal treatment step. The revolution speed of the planetary ball mill is preferably 300 rpm or higher. At a revolution speed lower than 300 rpm, pulverization was not carried out, and a desired substance could not be obtained in the below-described thermal treatment step.

The pulverized LiCoPO₄ and LiI were mixed in a mortar, to obtain a mixture (precursor). A crucible was filled with the obtained mixture and the obtained mixture was heated at 400° C. for 24 hours in an argon atmosphere, using an electric furnace, to obtain Li₃CoPO₄I₂. A gas other than argon may be used in the atmosphere, so long as the gas is an inert gas, and for instance helium, neon, nitrogen or the like can be used herein. A heating time of 12 hours or more was necessary; when the heating time was shorter than this the desired substance failed to be obtained.

In the preparation examples (i) to (viii) above, a solid-phase synthesis method was resorted to in which pulverized starting materials were mixed using a planetary ball mill, and a crucible was filled with the starting materials, and the starting materials were heated in an electric furnace. For the purpose of reaction promotion, however, heating may be carried out after production of pellets through pressing of the pulverized starting materials. The method is not limited to a solid-phase synthesis method, and for instance a liquid-phase synthesis method such as a hydrothermal method, or a gas-phase synthesis method, may be resorted to herein.

(II) Charging/Discharge Test

### Example 1

The charging/discharge characteristics of the lithium ion secondary battery of Example 1 were measured. In the lithium ion secondary battery of the present example, the Li₃CoPO₄F₂ (lithium oxide) of preparation example (v) was used as the positive electrode active material.

In the present example there was carried out a mixing step of carbon-coating the Li₃CoPO₄F₂ having been produced in preparation example (v). Specifically, the Li₃CoPO₄F₂ of preparation example (v), carbon which is a conductive aid, and polyvinylidene difluoride (PVDF), were mixed (carbon coating) at a proportion of 90:9:1, after which the mixture was applied on a collector foil using a bar coater, followed by drying for 24 hours or longer, to yield the positive electrode active material of the present example. Aluminum was used in the collector foil, and fibrous carbon was used as the carbon. In the present example the carbon was pulverized and mixed using a planetary ball mill.

To assemble a lithium ion secondary battery, a negative electrode, a separator and a positive electrode are assembled in this order, in a coin cell, after which an electrolyte solution is enclosed, with pressing to thereby enclose all the materials inside the coin cell. Stainless steel was used in the negative electrode, and an organic electrolyte solution resulting from dissolving lithium bis(trifluoromethanesulfonyl)imide (LiTFSI) as a lithium salt, to a concentration of 1 mol/L, was used as the electrolyte solution. The lithium ion secondary battery of the present example was produced as a result of the above steps.

The charging/discharge test was performed using a general charging/discharge system (SD8 charging/discharge system, by Hokuto Denko Corporation). The charging conditions included energization at 10 μA/cm² of current density per effective surface area of a positive electrode film, with the end-of-charge voltage is set to 5.0 V.

The discharge conditions included discharge at a current density of 10 μA/cm², with the discharge cut-off voltage set to 2.0 V. The charging/discharge test was performed in a thermostatic bath at 25° C. (the atmosphere was an ordinary atmospheric environment).

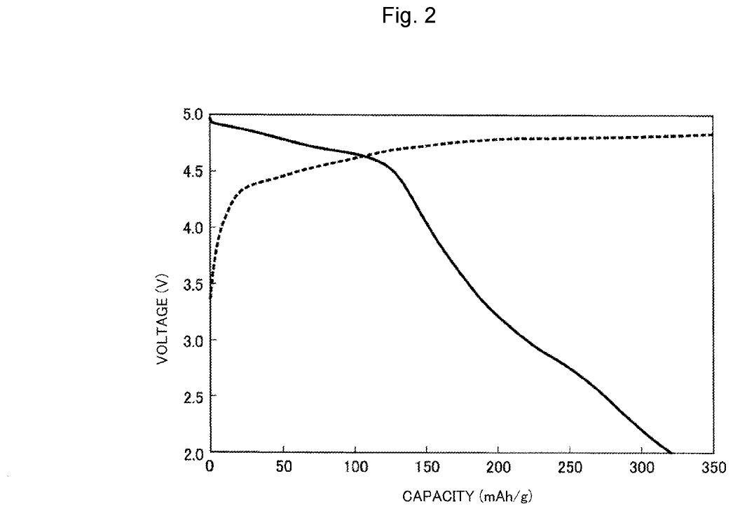

FIG. 2 illustrates the charging/discharge characteristics of the lithium ion secondary battery of the present example. The horizontal axis of FIG. 2 is capacity (mAh/g), and the vertical axis battery voltage (V). The dashed line in FIG. 2 denotes a charging characteristic, and the solid line denotes a discharge characteristic. The lithium ion secondary battery according to the present example can be charged and discharged reversibly; from the discharge characteristic it is found that the actual capacity is 320 mAh/g.

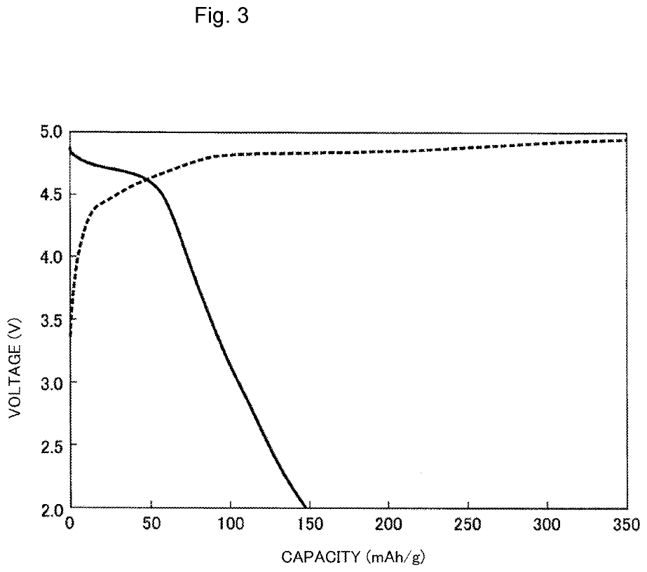

FIG. 3 illustrates, as a comparative example, charging/discharge characteristics of a lithium ion secondary battery produced using Li₂CoPO₄F as the positive electrode active material. In FIG. 3, the dashed line denotes a charging characteristic, and the solid line denotes a discharge characteristic. The discharge characteristic reveals that the actual capacity in the comparative example is 148 mAh/g.

The actual capacity of the present example illustrated in FIG. 2 is 320 mAh/g, which entails a significant increase as compared with the actual capacity of the comparative example (148 mAh/g). The theoretical capacity of Li₃CoPO₄F₂ in the present example is 378 mAh/g, and thus energy density is increased as compared with the theoretical capacity (287 mAh/g) of Li₂CoPO₄F of the comparative example, which is the starting material.

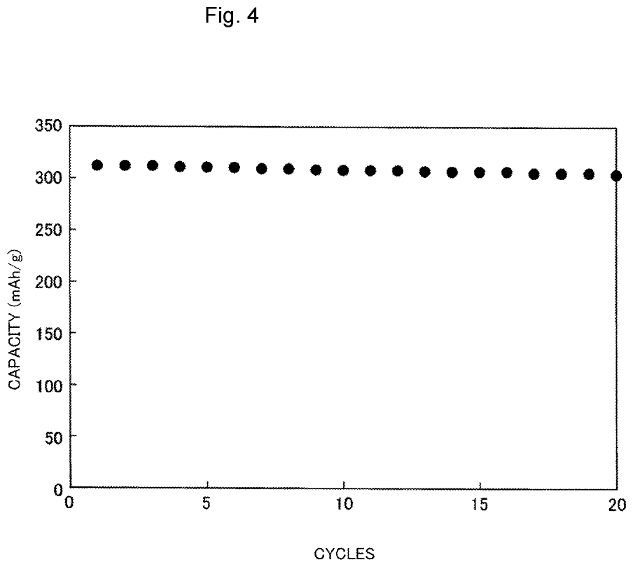

FIG. 4 is a diagram illustrating charging and discharge cycle characteristic of the lithium ion secondary battery of the present example. The horizontal axis in FIG. 4 is the number of (cycles) in charging/discharge cycling, and the vertical axis the discharge capacity (mAh/g). Table 1 sets out the average discharge voltage and discharge capacity in the first cycle, and a discharge capacity retention rate in the 20th cycle.

As FIG. 4 and Table 1 reveal, the drop in discharge capacity in the present example is about 6 mAh/g, which is indicative of stable charging and discharge cycle characteristic. That is, the lithium ion secondary battery of the present example has high energy density. As Table 1 illustrates, the average discharge voltage in the present example is 4.9 V, which is a high voltage.

TABLE 1

| | | First cycle | | Discharge |
|---|---|---|---|---|
| | | Average discharge | Discharge | capacity |
| Preparation | | voltage | capacity | retention rate |
| example | Example | (V) | (mAh) | in 20th cycle |
| i | 2 | 4.9 | 284 | 98% |
| ii | 3 | 4.8 | 252 | 98% |
| iii | 4 | 4.7 | 194 | 97% |
| iv | 5 | 4.6 | 156 | 96% |
| V | 1 | 4.9 | 320 | 98% |
| vi | 6 | 4.8 | 303 | 98% |
| vii | 7 | 4.7 | 233 | 97% |
| viii | 8 | 4.6 | 188 | 96% |

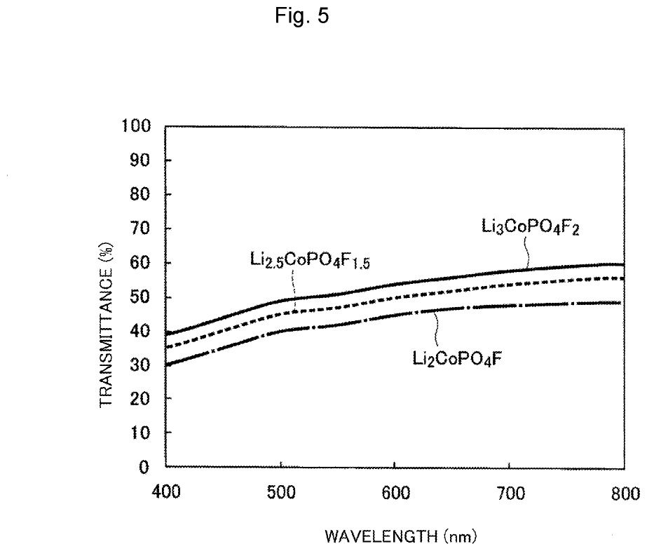

FIG. 5 is a diagram illustrating light transmission characteristics upon application of the Li₃CoPO₄F₂ and Li_{2.5}CoPO₄F_{1.5} prepared in preparation examples (v) and (i) on a glass substrate. The horizontal axis in FIG. 5 is light wavelength (nm) and the vertical axis light transmittance (%). The solid line in FIG. 5 denotes a light transmission characteristic of a glass substrate coated with Li₃CoPO₄F₂, the dashed line denotes a light transmission characteristic of a glass substrate coated with Li_{2.5}CoPO₄F_{1.5}, and the dot-chain line denotes a light transmission characteristic of a glass substrate coated with Li₂CoPO₄F as a comparative example. As FIG. 5 illustrates, Li₃CoPO₄F₂ exhibits an improved light transmission characteristic in the wavelength range of visible light (from about 400 nm to 780 nm), as compared with Li₂CoPO₄F.

As pointed out above, the lithium ion secondary battery of the present example has a stable charge cycle characteristic with high energy density and high voltage. Further, Li₃CoPO₄F₂ which is the positive electrode active material of the present example, exhibits a high light transmission characteristic.

### Example 2

Using the Li_{2.5}CoPO₄F_{1.5} prepared in preparation example (i), the lithium ion secondary battery of the present example was produced under the same conditions as in Example 1, and a charging/discharge test of the lithium ion secondary battery was carried out.

As Table 1 reveals, the drop in discharge capacity in the present example after 20 cycles is about 6 mAh, which is indicative of stable charging and discharge cycle characteristic. That is, the lithium ion secondary battery of the present example has high energy density. As Table 1 illustrates, the average discharge voltage in the present example is 4.9 V, which is a high voltage.

As FIG. 5 illustrates, Li_{2.5}CoPO₄F_{1.5} exhibits improved light transmission characteristic in the wavelength range of visible light (from about 400 nm to 780 nm), as compared with Li₂CoPO₄F.

### Example 3

Using the Li_{2.5}CoPO₄Cl_{1.5} prepared in preparation example (ii), the lithium ion secondary battery of the present example was produced under the same conditions as in Example 1, and a charging/discharge test of the lithium ion secondary battery was carried out.

As Table 1 reveals, the drop in discharge capacity in the present example after 20 cycles is about 5 mAh, which is indicative of stable charging and discharge cycle characteristic. That is, the lithium ion secondary battery of the present example has high energy density. As Table 1 illustrates, the average discharge voltage in the present example is 4.8 V, which is a high voltage.

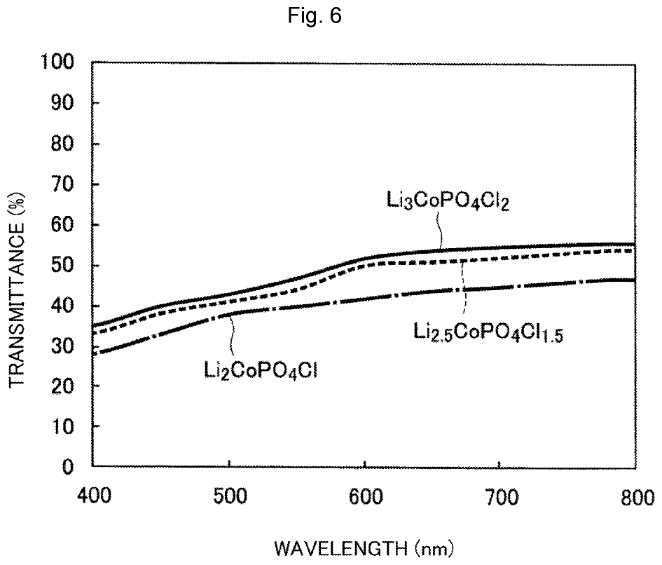

FIG. 6 is a diagram illustrating light transmission characteristics upon application of the Li_{2.5}CoPO₄Cl_{1.5} and Li₃CoPO₄Cl₂ prepared in preparation examples (ii) and (vi), on a glass substrate. The horizontal axis in FIG. 6 is light wavelength (nm) and the vertical axis light transmittance (%). The solid line in FIG. 6 denotes a light transmission characteristic of a glass substrate coated with Li₃CoPO₄Cl₂, the dashed line denotes a light transmission characteristic of a glass substrate coated with Li_{2.5}CoPO₄Cl_{1.5}, and the dot-chain line denotes a light transmission characteristic of a glass substrate coated with Li₂CoPO₄Cl as a comparative example. As FIG. 6 illustrates, Li_{2.5}CoPO₄Cl_{1.5} exhibits improved light transmission characteristic in the wavelength range of visible light (from about 400 nm to 780 nm), as compared with Li₂CoPO₄Cl.

### Example 4

Using the Li_{2.5}CoPO₄Br_{1.5} prepared in preparation example (iii), the lithium ion secondary battery of the description of the present example was produced under the same conditions as in Example 1, and a charging/discharge test of the lithium ion secondary battery was carried out.

As Table 1 reveals, the drop in discharge capacity in the present example after 20 cycles is about 6 mAh, which is indicative of stable charging and discharge cycle characteristic. That is, the lithium ion secondary battery of the present example has high energy density. As Table 1 illustrates, the average discharge voltage in the present example is 4.7 V, which is a high voltage.

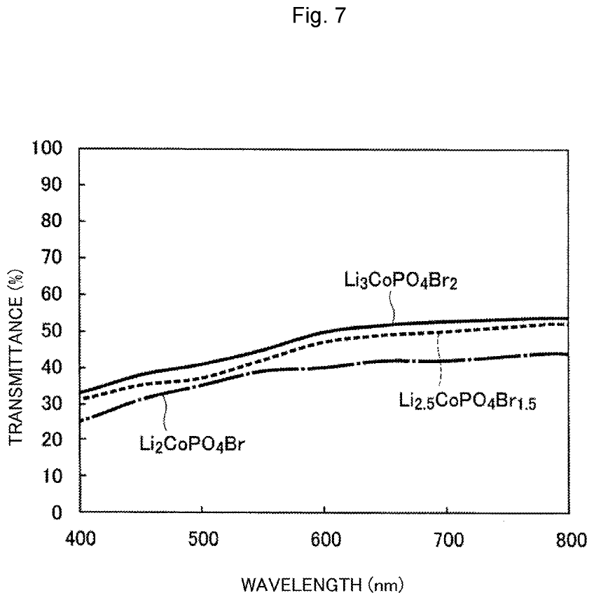

FIG. 7 is a diagram illustrating light transmission characteristics upon application of the Li_{2.5}CoPO₄Br_{1.5} and Li₃CoPO₄Br₂ prepared in preparation examples (iii) and (vii) on a glass substrate. The horizontal axis in FIG. 7 is light wavelength (nm) and the vertical axis light transmittance (%). The solid line in FIG. 7 denotes a light transmission characteristic of a glass substrate coated with Li₃CoPO₄Br₂, the dashed line denotes a light transmission characteristic of a glass substrate coated with Li_{2.5}CoPO₄Br_{1.5}, and the dot-chain line denotes a light transmission characteristic of a glass substrate coated with Li₂CoPO₄Br as a comparative example. As FIG. 7 illustrates, Li_{2.5}CoPO₄Br_{1.5} exhibits improved light transmission characteristic in the wavelength range of visible light (from about 400 nm to 780 nm), as compared with Li₂CoPO₄Br.

### Example 5

Using the Li_{2.5}CoPO₄I_{1.5} prepared in preparation example (iv), the lithium ion secondary battery of the description of the present example was produced under the same conditions as in Example 1, and a charging/discharge test of the lithium ion secondary battery was carried out.

As Table 1 reveals, the drop in discharge capacity in the present example after 20 cycles is about 6 mAh, which is indicative of stable charging and discharge cycle characteristic. That is, the lithium ion secondary battery of the present example has high energy density. As Table 1 illustrates, the average discharge voltage in the present example is 4.6 V, which is a high voltage.

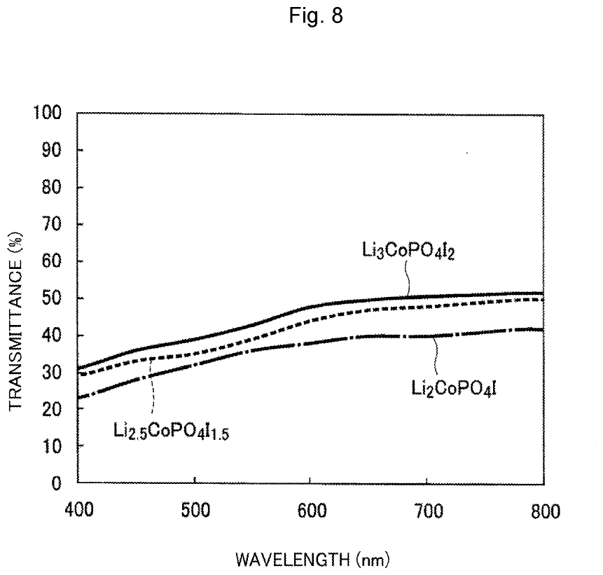

FIG. 8 is a diagram illustrating light transmission characteristics upon application of the Li_{2.5}CoPO₄I_{1.5} and Li₃CoPO₄I₂ prepared in preparation examples (iv) and (viii), on a glass substrate. The horizontal axis in FIG. 8 is light wavelength (nm) and the vertical axis light transmittance (%). The solid line in FIG. 8 denotes a light transmission characteristic of a glass substrate coated with Li₃CoPO₄I₂, the dashed line denotes a light transmission characteristic of a glass substrate coated with Li_{2.5}CoPO₄I_{1.5}, the dot-chain line denotes a light transmission characteristic of a glass substrate coated with Li₂CoPO₄I as a comparative example. As FIG. 8 illustrates, Li_{2.5}CoPO₄I_{1.5} exhibits improved light transmission characteristic in the wavelength range of visible light (from about 400 nm to 780 nm), as compared with Li₂CoPO₄I.

### Example 6

Using the Li₃CoPO₄Cl₂ prepared in preparation example (vi), a lithium ion secondary battery was produced under the same conditions as in Example 1, and a charging/discharge test of the lithium ion secondary battery was carried out.

As Table 1 reveals, the drop in discharge capacity in the present example after 20 cycles is about 6 mAh, which is indicative of stable charging and discharge cycle characteristic. That is, the lithium ion secondary battery of the present example has high energy density. As Table 1 illustrates, the average discharge voltage in the present example is 4.8 V, which is a high voltage.

As FIG. 6 illustrates, Li₃CoPO₄Cl₂ exhibits improved light transmission characteristic in the wavelength range of visible light (from about 400 nm to 780 nm), as compared with Li₂CoPO₄Cl.

### Example 7

Using the Li₃CoPO₄Br₂ prepared in preparation example (vii), a lithium ion secondary battery was produced under the same conditions as in Example 1, and a charging/discharge test of the lithium ion secondary battery was carried out.

As Table 1 reveals, the drop in discharge capacity in the present example after 20 cycles is about 7 mAh, which is indicative of stable charging and discharge cycle characteristic. That is, the lithium ion secondary battery of the present example has high energy density. As Table 1 illustrates, the average discharge voltage in the present example is 4.7 V, which is a high voltage.

As FIG. 7 illustrates, Li₃CoPO₄Br₂ exhibits improved light transmission characteristic in the wavelength range of visible light (from about 400 nm to 780 nm), as compared with Li₂CoPO₄Br.

### Example 8

Using the Li₃CoPO₄I₂ prepared in preparation example (viii), a lithium ion secondary battery was produced under the same conditions as in Example 1, and a charging/discharge test of the lithium ion secondary battery was carried out.

As Table 1 reveals, the drop in discharge capacity in the present example after 20 cycles is about 8 mAh, which is indicative of stable charging and discharge cycle characteristic. That is, the lithium ion secondary battery of the present example has high energy density. As Table 1 illustrates, the average discharge voltage in the present example is 4.6 V, which is a high voltage.

As FIG. 8 illustrates, Li₃CoPO₄I₂ exhibits improved light transmission characteristic in the wavelength range of visible light (from about 400 nm to 780 nm), as compared with Li₂CoPO₄I.

The present embodiment described above allows thus providing a high-voltage lithium ion secondary battery having high transparency to visible light and high energy density, and a method for producing the lithium ion secondary battery. Further, the lithium ion secondary battery of the present embodiment can be used for instance as a drive source in various electronic devices.

The present invention is not limited to the above embodiments, and can accommodate various modifications and combinations within the technical idea of the invention.

### REFERENCE SIGNS LIST

100 Lithium ion secondary battery
1 Negative electrode
2 Separator
3 Positive electrode
31 Positive electrode active material
32 Collector foil
4 Electrolyte solution

1. A lithium ion secondary battery comprising:
as a positive electrode active material into and from which lithium ions can be intercalated and deintercalated, a lithium oxide represented by Formula Li (1+y) CoPO₄X (y) (in the formula, X is selected from the group consisting of F, Cl, Br and I, and y lies in the range of 1<y≤2).

2. A method for producing a lithium ion secondary battery, the method comprising:
a mixing and pulverizing step of obtaining a precursor by mixing and pulverizing a starting material containing Formula LiCoPO₄, and formula yLiX (in the formula, X is selected from the group consisting of F, Cl, Br and I, and y lies in the range of 1<y≤2), within a container having an inert gas enclosed therein; and
a thermal treatment step of obtaining a positive electrode active material represented by Formula Li (1+y) CoPO₄X (y) (in the formula, X is selected from the group consisting of F, Cl, Br and I, and y lies in the range of 1<y≤2), by thermally treating said precursor in an inert gas.

3. The method for producing a lithium ion secondary battery of claim 2, comprising:
a mixing step of carbon-coating said positive electrode active material.
